(19) United States
(12) Patent Application Publication
(10) Pub. No.: US 2026/0205990 A1
(43) Pub. Date: Jul. 16, 2026

(54) NETWORK NODE AND METHOD IN A WIRELESS COMMUNICATIONS NETWORK

(71) Applicant: Telefonaktiebolaget LM Ericsson (publ), Stockholm (SE)

(72) Inventors: Mohammad Reza GHOLAMI, Stockholm (SE); Rerngvit YANGGRATOKE, Jarfalla (SE); Ebby GEORGE, Solna (SE)

(21) Appl. No.: 19/141,132

(22) PCT Filed: Dec. 21, 2022
(86) PCT No.: PCT/SE2022/051214

§ 371 Date: Jun. 19, 2025

(51) Int. Cl. H04W 64/00

(52) U.S. Cl. CPC H04W 64/00

(57) ABSTRACT

Provided is a method, performed by a network node, for estimating a position (Y) of a first antenna in a wireless communications network—comprising: Identifying (501) a set of first User Equipment, UE, with unknown positions, that the first antenna serves. Obtaining (502) a known position of each second antenna in a set of second antennas. Each second antenna is serving at least one second UE with an unknown position. Obtaining (503) first radio measurements between: —(i) each second antenna and it's respective at least one served second UE, and —(ii) the first antenna and it's respective at least one served first UE. Obtaining (504) second radio measurements over sidelinks between each first UE and the respective at least one second UE. Estimating (505) the position (Y) of the first antenna based on: —the known position of each second antenna, —the first and second radio measurements.

### TECHNICAL FIELD

Embodiments herein relate to a network node and methods therein. In some aspects, they relate to estimating a position of a first antenna in a wireless communications network.

### BACKGROUND

In a typical wireless communication network, such as e.g. a mobile network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point, a Base Station (BS) or a radio base station (RBS), which in some networks may also be denoted, for example, a Base Station (BS), a NodeB, eNodeB (eNB), or gNodeB (gNB) as denoted in Fifth Generation (5G) telecommunications. A service area or cell area is a geographical area where radio coverage is provided by the radio network node. The radio network node communicates over an air interface operating on a radio frequency with the wireless devices within the range of the radio network node.

3rd Generation Partnership Project (3GPP) is the standardization body for specifying the standards for the cellular system evolution, e.g., including 3G, 4G, 5G and the future evolutions. Specifications for Evolved Universal Terrestrial Radio Access (E-UTRA) and Evolved Packet System (EPS) have been completed within the 3GPP. In 4G also called a Fourth Generation (4G) network, EPS is core network and E-UTRA is radio access network. In 5G, 5GC is core network, NR is radio access network. As a continued network evolution, the new release of 3GPP specifies a 5G network also referred to as 5G New Radio (NR) and 5G Core (5GC).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station (BS), the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. The cell capacity can be increased linearly with respect to the number of antennas at the BS side. Due to that, more and more antennas are employed in BS. Such systems and/or related techniques are commonly referred to as massive MIMO.

A base station comprises various components, e.g., radio units (RU)s, power supply, etc. The RU is the radio frequency processing unit that transmits and receives radio signals over a radio interface. RU contains different components. A radio antenna is one of the main components of an RU. The radio antenna units are central parts of a wireless communications network. Their positions (x, y, z) and directions are important data when planning the radio network to optimize coverage and capacity, fundamental aspects for how to provide UEs with target connectivity service quality levels. In some scenarios, the antenna is installed close to a RU, but in some situations the antenna could be far from a RU.

The radio antenna units' positions, also referred to as position information, are used when allocating a sector carrier frequency to it, e.g., when a new antenna is mounted to a base station. Information about geographical locations of an antennas associated with RUs is typically configured into a data base, often in Configuration Management (CM). The location information may be obtained manually or via Global Positioning System (GPS), if available. The location information may have large errors or even might be missing. In addition, equipping an antenna with GPS may be costly. Lack of access to GPS satellite also results in poor accuracy.

New Radio Side Link (NR SL) is a 3GPP protocol for direct communication between UEs, and not via a base station or gNB. The protocol enables peer-to-peer communication among UEs within a mobile network. FIG. 1 presents the protocol stack for both UE user plane and UE control plane, while 3GPP, “TS 38.300, NR; NR and NG-RAN Overall description; Stage-2,” and 3GPP, “TS 23.287, Architecture enhancements for 5G System (5GS) to support Vehicle-to-Everything (V2X) services” explain detailed description of functionality for each layer.

FIG. 2 depicts 3GPP NG-RAN Release 15 Location Services (LCS) Protocols illustrating a general overview of entities involved in data gathering for UE positioning. The Location Management Function (LMF), which is central in 5G positioning, receives measurements from NG-RAN and UE via the Access and Mobility Function (AMF) over the NLs interface. A new protocol was introduced in the 3GPP release 16 called NR Positioning Protocol A (NRPPa) to carry the position information between NG-RAN and a Location Management Function (LMF). The LMF configures the UEs through LTE positioning protocol via AMG while the NG RAN configures UE using Radio Resource Control (RRC) protocol over LTE-Uu and NR-Uu. It should be noted that the gNB and ng-eNB may not always both be present, and when both the gNB and ng-eNB are present, the NG-C interface is only present for one of them.

In a Sector Carrier Orchestration (SCO) use case, a concept called SCO low abstraction level intent is used, which gives customers a way to express site generic input and Open/Closed Loop preferences. The SCO low abstraction level intent is part of Day 1 configurations. In details, in Day-0, the configuration required to enable a RAN agnostic deployment using Cloud Infrastructure. The end results being that a first version of an North Bound Interface (NBI) is available, providing a CM interface towards a management entity. In Day-1, the RAN specific configuration in logical view makes a RAN Network Function available and operational. And Day-N, it represents software change in deployment view as well as configuration changes in logical view.

The SCO low abstraction level intent provides a template used for creating Antenna Function (AF), SEF, NR Sector Carrier, NR Cell, Distributed Unite (DU), etc. for a given geographical area, e.g., one or more latitude and/or longitude polygons. An SCO RAN Assurance and Development Application (RAD-APP) (SCO RAD) Application needs to determine whether a newly installed RU's antenna is located within a geographic area in order to apply a corresponding template to create Antenna Function, SEF, NR Sector Carrier, NR Cell DU MOs. That is the reason why the Antenna Positioning RAD Application is needed to provide the RU antenna position.

Information about the position of the antenna is a vital requirement for the SCO use case. A problem is that the position of the antenna may not be available, it may e.g. be missing, or may be subject to large errors.

### SUMMARY

An object of embodiments herein is to improve the way of estimate the geographical position of an antenna in a wireless communications network.

According to an aspect of embodiments herein, the object is achieved by a method performed by a network node to estimate a position (Y) of a first antenna in a wireless communications network.

The network node identifies a set of first User Equipment, UE, with a respective unknown position, that the first antenna serves. The network node obtains a known position of each respective second antenna in a set of second antennas. Each second antenna in the set of second antennas, is serving at least one second UE with an unknown position.

The network node obtains first radio measurements between:
(i) each second antenna in the set of second antennas and it's respective at least one served second UE, and between
(ii) the first antenna and its respective at least one served first UE.

The network node obtains second radio measurements over sidelinks between each first UE of the set of first UE and the respective at least one second UE served by each respective second antenna in the set of second antennas.

The network node then estimates the position (Y) of the first antenna based on:
the known position of each second antenna in the set of second antennas,
the first radio measurements, and
the second radio measurements.

According to another aspect of embodiments herein, the object is achieved by a network node configured to estimate a position (Y) of a first antenna in a wireless communications network. The network node further is configured to:
Identify a set of first User Equipment, UE, with a respective unknown position, that the first antenna serves,
obtain a known position of each respective second antenna in a set of second antennas, wherein each second antenna in the set of second antennas, is adapted to serve at least one second UE with an unknown position, and
obtain first radio measurements between:
   (i) each second antenna in the set of second antennas and it's respective at least one served second UE, and between
   (ii) the first antenna and its respective at least one served first UE,
obtain second radio measurements over sidelinks between each first UE of the set of first UE and the respective at least one second UE served by each respective second antenna in the set of second antennas,
estimate the position (Y) of the first antenna based on:
   the known position of each second antenna in the set of second antennas,
   the first radio measurements, and
   the second radio measurements.

Some advantages of embodiments herein e.g. comprise:

An automated and efficient method that does not require manual efforts and will reduce operational cost for estimating antenna location.

They may use extra measurements that do not pose heavy load and/or processing and/or resources from the network.

They allow for privacy-preserving data collection to determine the target antenna position. In other words, it does not assume collection and sharing of UE locations.

This results in an improved way of estimating the geographical position of an antenna in a wireless communications network.

### BRIEF DESCRIPTION OF THE DRAWINGS

Examples of embodiments herein are described in more detail with reference to attached drawings in which:

FIG. 1 is a schematic block diagram illustrating prior art.

FIG. 2 is a schematic block diagram illustrating prior art.

FIG. 3 is a schematic block diagram illustrating embodiments of a wireless communications network.

FIG. 4 is a schematic block diagram illustrating embodiments of a wireless communications network.

FIGS. 5 a and b are flowcharts depicting an embodiment of a method in a network node.

FIG. 6a is a schematic block diagram illustrating embodiments herein.

FIG. 6b is a flowchart depicting an embodiment of a method in a network node.

FIG. 7 is a schematic block diagram illustrating embodiments herein.

FIG. 8 is a schematic block diagram illustrating embodiments of a network node.

### DETAILED DESCRIPTION

As a part of developing embodiments herein a problem was identified by the inventors and will first be discussed.

An alternative to solve the problem as mentioned above, is to extract the location of an antenna, e.g., when a new antenna is installed in the field. While the UEs positioning has been vastly explored in the literature, see e.g. M. R. Gholami, Wireless sensor network positioning techniques, Gothenburg: Chalmers, 2013, there are a few studies in antenna positioning problem.

A GPS-based method: An RU antenna usually is equipped with GPS receiver port. While the GPS technology may provide accurate estimates of the location, it may face critical drawbacks in various situations, mainly due to blockage of satellite signals in indoor scenarios. In addition, equipping antenna with GPS receiver will add extra cost to the system.

A Manual setting: Traditionally, the antenna geo-position of an RU is measured and set by a field technician. There are drawbacks with this approach too, e.g., setting wrong value, measuring wrong location, sometimes antennas are far from the RU. Also, this approach is subject to time and cost.

Examples of embodiments herein provide a method for estimating antenna position, by using sidelink measurements.

Some of the examples of embodiments herein relate to terms such as antenna positioning, telecommunication, Cloud RAN, artificial intelligence, machine learning, RU positioning, and sidelink communication.

According to an example method of embodiments herein, the location of an antenna is estimated, e.g., when a new antenna is installed in the field. The position of the antenna is estimated by using measurements between neighbouring antennas and UEs that they serve, referred to as first measurements herein. Further, by using additional measurements, referred to as second measurements, between UEs, the so-called sidelink measurements.

Example embodiments herein take as input:
1.) radio measurements between antennas and UEs,
2.) radio measurements between UEs over side link (NR SL),
3.) known locations of a few antennas, and
4.) identifier of a target antenna connected by target UEs.

Then, an estimation of the position of the target antenna, referred to as first antenna herein is provided as output, such as e.g. antenna location comprising an accuracy metric in terms of e.g., 95% confidence interval.

In some examples of embodiments herein, a method for antenna positioning is provided that uses regular measurements between UEs and antenna plus sidelink information. The method may e.g., be implemented either in one shot or in a three consecutive steps. Some examples of embodiments herein e.g. comprise:

Using sidelink measurements, such as e.g., Reference Signal Receive Power (RSRP), Reference Signal Received Quality (RSRQ), Received Signal Strength Indicator (RSSI), Time of Arrival (TOA), and/or Round-Trip Time (RTT) along with cell trace measurements such as e.g. RSRP Quality (Q), RSSI, Timing Advance (TA), TOA, RTT, Angel of Arrival (AOA), and/or doppler shift, to estimate the location of an antenna.

A direct method to estimate the location of the antenna, where all measurements are used to estimate the location of the antenna based on the location of the other antennas at known locations. The direct method overcomes an optimization problem and gets estimates of all unknown positions, both UEs and Antenna locations.

A three-step estimator, where the locations of UEs are estimated first, if not available through GPS, then the position or location of a target UE is determined via sidelink measurements and finally the antenna location is estimated.

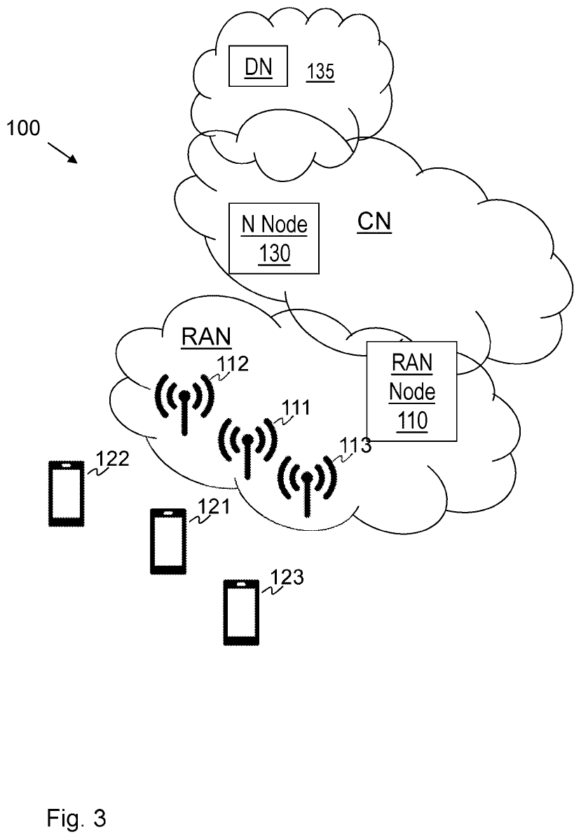

FIG. 3 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, 6G, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes, such as a RAN node 110, operate in the wireless communications network 100. The RAN node 110 is associate with a number of antennas, e.g. a cluster of antennas, comprising e.g. a first antenna 111, one or more second antennas 112 comprised in a set of second antennas and e.g. one or more third antennas 113 comprised in a set of third antennas. The antennas 111, 112, 113 may be located in the same location as its associated RU position or it may be installed far from its RU, e.g., in a building.

The respective antenna 111, 112, 113 will serve corresponding cells and be used to communicate with UEs, e.g. one or more first UEs 121, one or more second UEs 122, and possibly one or more third UEs 123. The respective antenna 111, 112, 113 may e.g. be a transmission and reception point operating for a RAN node such as the RAN node 110. The RAN node 110 may e.g. be e.g. a base station, a radio access network node such as a base station, a radio base station, a NodeB, an evolved Node B (eNB, eNodeB, eNode B), an NR/g Node B (gNB), a base transceiver station, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE served by the network node 110 depending e.g. on the radio access technology and terminology used.

A number of UEs, e.g. a cluster of UEs operate in the wireless communications network 100, such as e.g. one or more first UEs 121 comprised in a set of first UE, one or more second UEs 122 comprised in a set of second UEs, and possibly one or more third UEs 123 comprised in a set of third UEs. The respective UE 121, 122, 123, may e.g. be an NR device, a mobile station, a wireless terminal, an NB-IoT device, an enhanced Machine Type Communication (eMTC) device, an NR RedCap device, a CAT-M device, a Vehicle-to-everything (V2X) device, Vehicle-to-Vehicle (V2V) device, a Vehicle-to-Pedestrian (V2P) device, a Vehicle-to-Infrastructure (V2I) device, and a Vehicle-to-Network (V2N) device, a Wi-Fi device, an LTE device and a non-access point (non-AP) STA, a STA, that communicates via one or more antennas such as the antennas 111, 112, 113, and a base station such as e.g. the RAN node 110, one or more Access Networks (AN), e.g. RAN, to one or more core networks (CN). It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

A number of network nodes operate in the wireless communications network 100, such as e.g., the network node 130. The network node 130 may e.g. be an SMO node or an LMF node.

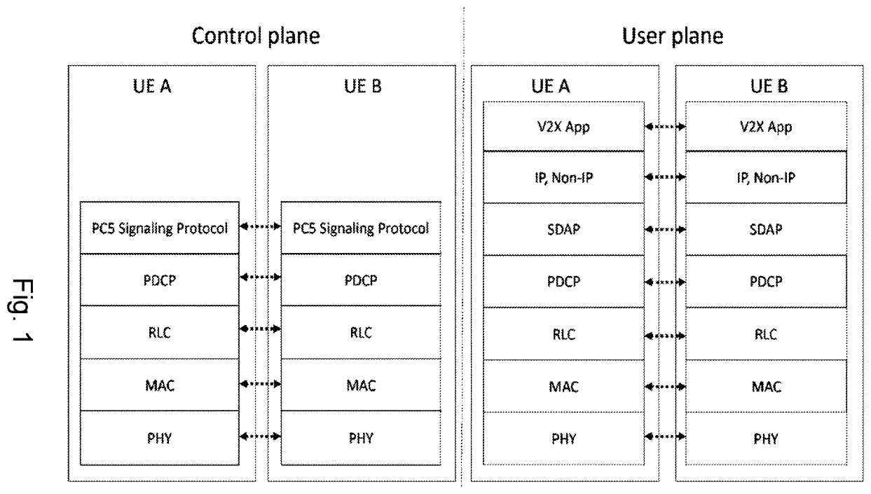

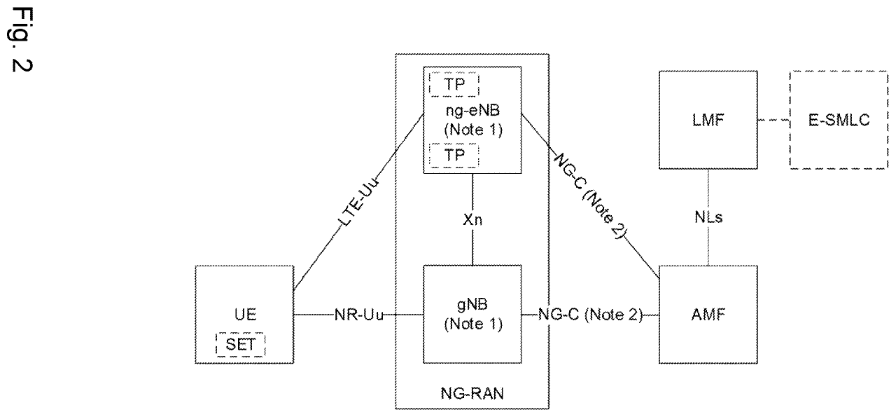

Methods herein may in one aspect be performed by the network node 130. As an alternative, a Distributed Node (DN) and functionality, e.g. comprised in a cloud 135 as shown in FIG. 1, may be used for performing or partly performing the methods of embodiments herein.

The entire method may be implemented in a virtualized or containerized service or micro-service running in the cloud 135 environment.

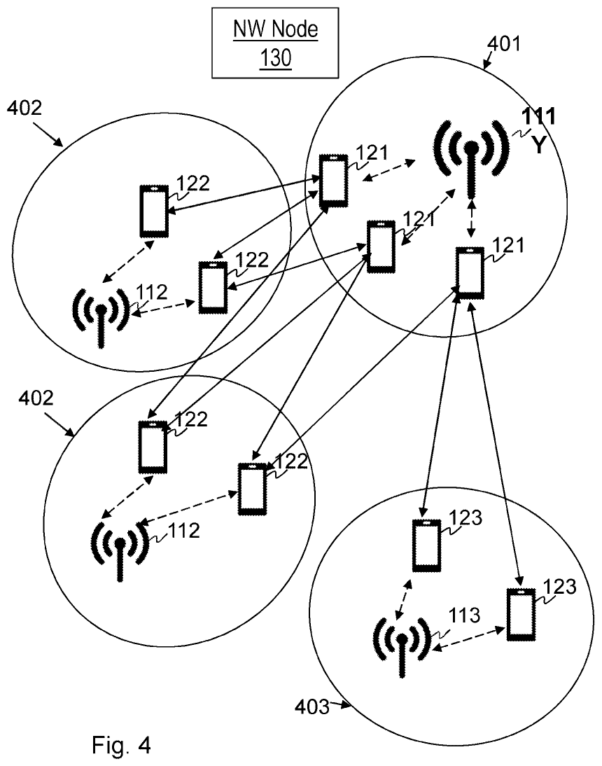

FIG. 4 shows an example scenario of embodiments herein. In this scenario, the first antenna 111 serves the one or more first UEs 121 in the set of first UE 121, e.g., in a first service area 401. The position Y of the first antenna 111 is unknown, or the accuracy of a known position may be below a certain desired value or otherwise corrupted. The position Y of the first antenna 111 will be estimated according to embodiments herein. The position of each respective first UE 121 in this example may be unknown.

A respective second antenna 112 in a set of second antennas, is serving at least one second UE 122 in the set of second UEs, e.g., in a second service area 402. The position of the respective second antenna 112 may be known. The position of each respective second UE 122 may be unknown.

In some embodiments, each respective third antenna 113 in a set of third antennas, is serving at least one third UE 123 in a set of third UEs, e.g., in a third service area 403. The position of each respective third antenna 113 is known. The position of each respective third UE 123 may be unknown.

It should be noted that there are a number of antennas related to the example scenario of embodiments herein, e.g. a cluster of similar antennas. To explain and different scenarios herein in a simple way, the antennas in the cluster of antennas are referred to as first antenna 111, second antennas 112 and third antennas 113.

Further, that there are a number of UEs related to the example scenario of embodiments herein, e.g. a cluster of UEs. To explain and different scenarios herein in a simple way, the UEs in the cluster of UEs are referred to as first UEs 121, second UEs 122 and third UEs 123.

According to an example scenario of embodiments herein, first radio measurements relating to measurements between antennas and UEs will be used as a basis for estimate a position Y of the first antenna 111 and are illustrated by dashed line arrows in FIG. 4. The network node 130 will further use sidelink measurements between UEs which are illustrated by unbroken line arrows in FIG. 4, as a basis for later on estimate the position Y of the first antenna 111. These are referred to as the second radio measurements herein.

Example embodiments herein e.g., provide a specific method to estimate an unknown location of the antenna 111 using side links.

Advantages of embodiments herein e.g., comprise the following:

The embodiments do not require manual efforts, i.e. no one needs to go to the actual antenna, which will reduce operational cost for estimating the first antenna 111 position. In embodiments herein, extra measurements are used that do not pose heavy load, processing, or resources from the wireless communications network 100.

They allow for privacy-preserving data collection to determine the first RU 111 position. In other words, they do not assume collection and sharing of UE locations.

A number of embodiments will now be described, some of which may be seen as alternatives, while some may be used in combination.

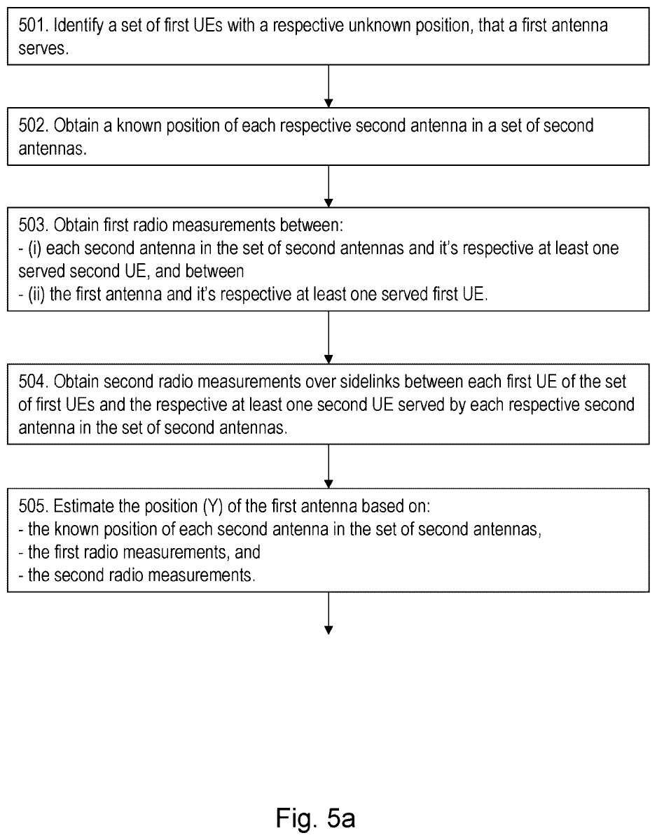

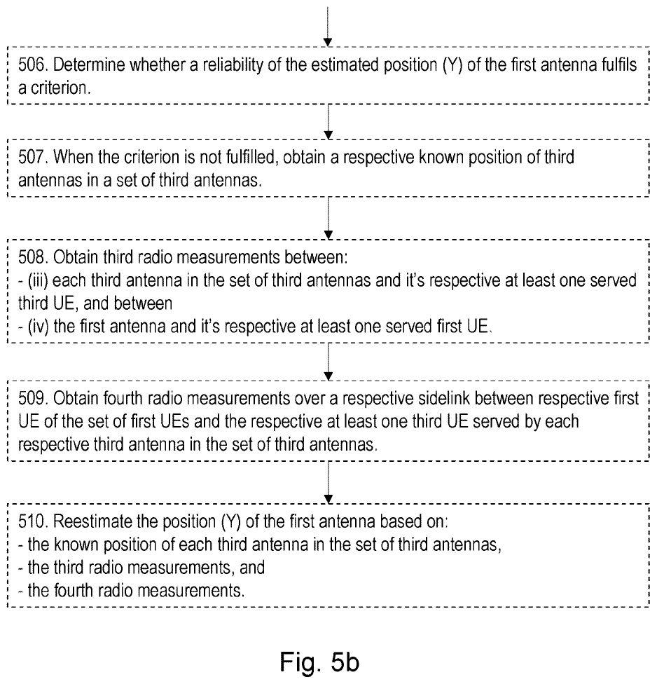

FIGS. 5a and b shows exemplary embodiments of a method performed by the network node 130. The method is for estimating a position Y of a first antenna 111 in a wireless communications network 100.

According to an example scenario herein, the position of the first antenna is unknown. This may e.g., be since the accuracy of the position estimate is not enough for a certain use case or it is not available at all. The method comprises the following actions, which actions may be taken in any suitable order. Optional actions are referred to as dashed boxes in FIG. 5b. FIG. 5a shows Actions 501-505 and FIG. 5b shows optional Actions 506-510.

### Action 501

The network node 130 identifies a set of first UE 121 with respective unknown positions. The first UEs 121 are served by the first antenna 111. The UEs 121 in the set of first UE 121 may e.g., be identified by the network as target UEs and will later on be used for sidelink measurements related to second radio measurements described below.

### Action 502

According to the example scenario, to be able to later on estimate the position Y of the first antenna 111, the network node 130 needs to know a position of each respective second antenna 112. The network node 130 obtains a known position of each respective second antenna 112 in a set of second antennas. Each second antenna 112 in the set of second antennas, is serving at least one second UE 122 with an unknown position. The respective at least one second UEs 122 will later on be used for sidelink measurements towards the first UEs 121, related to second radio measurements described below.

The obtaining of the known position of the of each second antenna 112 in the set of second antennas, may e.g., be performed by cell trace measurements. This may mean that the known position of each respective second antenna 112 network node 130 may be obtained by performing cell trace measurements, or it may be extracted from CM data.

### Action 503

The network node 130 obtains first radio measurements between:
i each second antenna 112 in the set of second antennas and its respective at least one served second UE 122, and between
ii the first antenna 111 and its respective at least one served first UE 121,

In some embodiments, the first radio measurements, further comprises radio measurements between:
iii each second antenna 112 in the set of second antennas and the first UE 121.

The first radio measurements may be comprised in cell trace measurements. For example, RSRP(Q) from an antenna that is neighbour to the first antenna 111 may be collected in handover processing mode.

According to the example scenario, the first radio measurements relate to measurements between antennas and UEs and will be used as a basis for later on estimate the position Y of the first antenna 111.

The obtained first radio measurements may e.g., relate to different measurements such as RSRP(Q), RSSI, TA, TOA, doppler shift, DL Positioning Reference Signal (PRS), UL-SRS, AOA.

Herein, the set of second antennas defines the antennas that are used in the first measurements in embodiments herein, accordingly each second antenna 112 is used for the first measurements.

### Action 504

According to embodiments herein, the network node 130 will further use sidelink measurements between UEs, referred to as the second radio measurements herein, as a basis for later on estimate the position Y of the first antenna 111. The second UEs 122 in the set of second UEs 122 which are the UEs that are used for the second radio measurements are radio measurements over sidelinks towards the first UEs 121, may preferably satisfy two conditions:
(a) The sidelink connection Signal to Noise Ratio (SNR) is above a threshold.
(b) The second UEs 122 should be connected to at least a number Nest of known antennas with SNRs above some threshold, e.g., SNR>10 dB. Where Nest is the minimum number of reference points (a UE or antenna point) required to estimate the location of the first antenna.

The network node 130 obtains second radio measurements. The second radio measurements are radio measurements over sidelinks. These sidelinks are between each first UE 121 of the set of first UE served by the first antenna 111, and the respective at least one second UE 122 served by each respective second antenna 112 in the set of second antennas.

Herein, the set of first UE served by the first antenna 111 defines the UEs that are used for the second measurements in embodiments herein, accordingly each first UE 121 is used for the second measurements. The obtained second radio measurements may e.g., relate to different measurements such as RSRP(Q), RSRI, TOA, RTT.

### Action 505

The network node 130 then estimates the position Y of the first antenna 111 based on:
the known position of each second antenna 112 in the set of second antennas,
the first radio measurements, and
the second radio measurements.

Some embodiments are examples of how the known position of each respective second antenna 112 in a set of second antennas, the first radio measurements, and the second radio measurements are obtained and/or used, and how the estimating of the position Y of the first antenna 111 is performed based on these.

The network node 130 estimates the position of each at least one second UE 122 served by each respective second antenna 112 in the set of second antennas, based on:
the first radio measurements i between each second antenna 112 in the set of second antennas and it's respective at least one served second UE 122,
the known position of each respective second antenna 112 in the set of second antennas.

The network node 130 further estimates the position of each of the respective first UEs 121 of the set of first UE based on:
the estimated position of each at least one second UE 122 served by each respective second antenna 112 in the set of second antennas, and
the second radio measurements.

The network node 130 then estimates the position Y of the first antenna 111 based on the position of each of the respective first UEs 121 of the set of first UE, and the first radio measurements between ii the first antenna 111 and it's respective at least one served first UE 121.

In this way, different types of measurements may be used to provide position estimates as accurate as possible. Depending of type of measurements, different algorithm may be deployed for the positioning purpose.

In some further embodiments the network node 130 checks a reliability of the estimated position Y of the first antenna 111. This is an advantage since it will check the accuracy level and may decide any further actions that should be taken, e.g., whether extra measurements need to be obtained or not. This will be explained more in detail below. In these embodiments the network node 130 may perform the optional Actions 506-510.

### Action 506

The network node 130 determines whether a reliability of the estimated position Y of the first antenna 111 fulfils a criterion. The criterion may e.g., relate to how accurate the measurements are based on the estimate, especially for distance-based and AOA type measurements.

### Action 507

When the criterion is not fulfilled, the network node 130 obtains a respective known position of third antennas 113 in a set of third antennas. Each third antenna 113 in the set of third antennas, is serving at least one third UE 123 with an unknown position.

According to embodiments herein, the network node 130 may use some further antennas and UEs, from the clusters, referred to as third antennas 113 and third UEs 123, for reestimating the position Y of the first antenna 111. Any of the third antennas 113 and third UEs 123 may e.g., be some or all of the second antennas 112 and second UEs 122.

### Action 508

In these embodiments, the network node 130 obtains third radio measurements between:
iii each third antenna 113 in the set of third antennas and it's respective at least one served third UE 123, and between
iv the first antenna 111 and it's respective at least one served first UE 121.

### Action 509

In these embodiments, the network node 130 further obtains fourth radio measurements over a respective sidelink between respective first UE 121 of the set of first UE and the respective at least one third UE 123 served by each respective third antenna 113 in the set of third antennas.

### Action 510

In these embodiments, the network node 130 then reestimates the position Y of the first antenna 111 based on:
the known position of each third antenna 113 in the set of third antennas,
the third radio measurements, and
the fourth radio measurements.

It should be noted, as also hinted above, that the third antennas 113 are just other antennas than the second antennas 112 within the cluster of antennas, that the third UEs 123 are just other UEs than the second UEs 122 within the cluster of UEs. Thus they are a part of the same cluster.

Embodiments herein such as the embodiments mentioned above will now be further described and exemplified. The text below is applicable to and may be combined with any suitable embodiment described above.

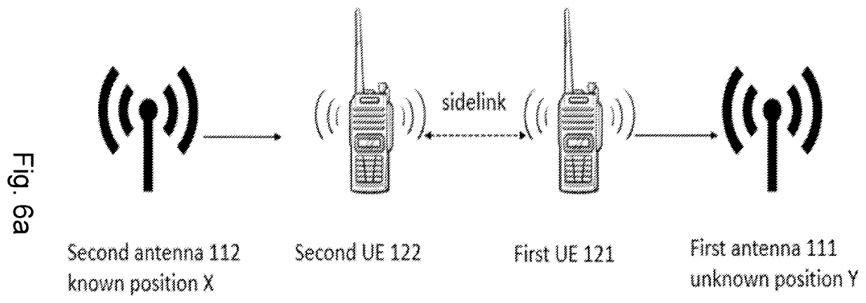

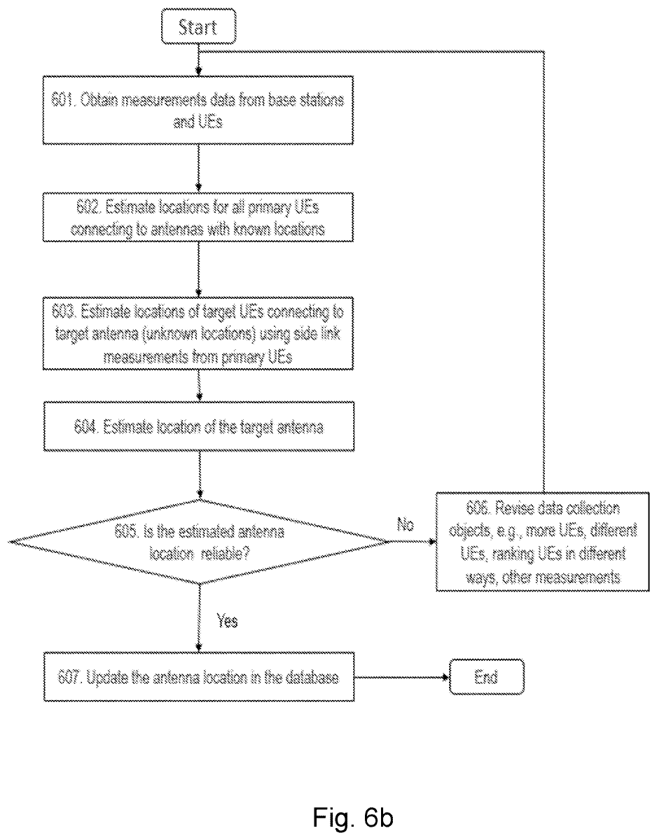

FIG. 6a depicts an example of embodiments herein illustrating an end-to-end connection via Sidelink from one of the second antennas 112 at the known location via the second UE 122, via the side link to the first UE 121 to the first antenna 111 at the unknown position to be estimated. There will be a number of such connections in the network. Second antenna 112 measurements, referred to as first radio measurements, for the second UEs 122 are collected, also referred to as obtained. Further, sidelink measurements, referred to as second radio measurements, for the target UEs, also referred to as the first UEs 121 are collected. This may for example be done in two different embodiments, backward data collection and forward data collection, exemplified below.

Backward data collection: An example of backward data collection may comprise the following steps:
1. In this embodiment, the network node 130 may start with the first antenna 111 with unknown antenna position Y. The network node 130 obtains first radio measurements such as e.g. collects high quality RSRP measurements. For RSRP, the measurements are first filtered, for example such that values above a threshold (>RSRP_{threshold}) are selected. For RSRP, this filtering is performed for every measurement, to get high quality RSRP.
2. If the number of first UEs 121 are less than Nest, the process is reiterated or another unknown antenna, if it exists, is selected and the process is repeated for the new antenna.
3. The network node 130 collects the sidelink measurements, referred to as second radio measurements, between the second UEs 122 and the first UEs 121. The second UEs 122 may preferably satisfy two conditions:
   (a) The sidelink connection Signal to Noise Ratio (SNR) is above some certain level.
   (b) The second UEs 122 should be connected to at least Nest known antennas with SNRs above some threshold, e.g., SNR>10 dB.
4. The network node 130 may then proceed with a next unknown antenna if it exists.

Forward data collection: An example of forward data collection may comprise the following steps:
1. In this embodiment, the network node 130 may start with one of the second antennas 112 with a known position. The network node 130 obtains, first radio measurements such as e.g., collects high quality RSRP measurements, e.g. RSRP measurements above a threshold, >RSRP_{threshold}, or SNR above some threshold, of the second UEs 122 connected to this second antenna 112.
2. The network node 130 collects the sidelink measurements, referred to as second radio measurements, exceeding an RSRP threshold, between first UEs 121 and the second UEs 122.
3. The network node 130 may filter out the first UEs 121 having less than Nest sidelink connections as their location cannot be estimated.
4. For an unknown antenna, such as the first antenna 111, if the number of first UEs>Nest, it is possible to predict the location Y of the first antenna 111.
5. The network node 130 may then proceed with a next known antenna if existing.

The backward data collection method has the advantage that it requires less measurements to be collected than the Forward data collection.

FIG. 6b presents an overview of an example of the method, which composes the following steps below. The method is expected to be run by the network node 130, e.g. in its computing apparatus. Examples of such network node 130, or network node 130 apparatus include, without limitation, a centralized device, a distributed device having distributed logical and/or physical entities, a standalone device in a location near the site, a border device, or an edge device.

It should be noted that the wordings “location” and “position” should be seen as equal and may be used interchangeably herein.

The network node 130 obtains 601 the first radio measurements data from antennas such as the second and possibly third antennas 112, 113 related to base stations such as e.g., RAN nodes 110 and UEs such as the first second and possibly third UEs 121, 122, 123. This is related to and may be combined with Action 503. The network node 130 obtains 602, also referred to as estimates, locations for all second UEs 122, referred to as primary UEs, connecting to the second antennas with known locations. This is related to and may be combined with Action 502. The network node 130 estimates 603 locations of the first UEs 121 such as the target UEs, connecting to the target antenna such as the first antenna 111 with the unknown location Y, by using side link measurements from the primary UEs such as the second UEs 122 to obtain the second radio measurement data. This is related to and may be combined with Action 504. The network node 130 obtains 604, also referred to as estimates, the location Y of the target antenna, such as the first antenna 111 the estimating is based on the known position of each second antenna 112, the first radio measurements, and, the second radio measurements. This is related to and may be combined with Action 505. The network node 130 may then check 605 whether the estimated antenna location Y is reliable or not. This is related to and may be combined with Action 506. If No, the network node 130 may then revise 606 data and obtain known positions, third and fourth radio measurement collection objects, e.g., based on more UEs, such as the third UEs 123, different UEs such as the third UEs 123, ranking UEs in different ways, other measurements. This is related to and may be combined with Actions 507-510. If yes, the network node 130 updates 607 the antenna location in a database in the CM.

Further elaboration of the different actions described above follows below with further embodiments. The following terminologies are used below:
RSRP_{threshold}: Threshold RSRP for a connection to be considered stable.
Nest: The minimum number of reference points (a UE or antenna point) required to estimate the location of a target node at unknown location (a UE or an antenna).
Primary UE: The second UE 122 connected to at least one second antenna 112 at known location.
Target UE: The first UEs 121 connected to the first antenna 111 whose position Y is to be estimated.
Target antenna: The first antenna 111 whose position is unknown or inaccurate and is to be estimated.

In some embodiments herein, the network node 130 may e.g., be triggered to start the method to estimate the position Y of the first antenna 111 when a new RU is installed or a re-assessment of the position of an antenna is requested, e.g., in case of an unreliable position. The network node 130 identifies the set of first UE 121 that are served by the first antenna 111. As described in Action 501 above.

The entities involved in data gathering for UE positioning general described in FIG. 2 above, may be used also for antenna positioning according to embodiments herein.

To enhance the accuracy of positioning for the first antenna 111, new reference signals may be introduced in NR specifications e.g., referred to as an NR Positioning Reference Signal (NR PRS) in DL and the Sounding Reference Signal (SRS) in UL. The PRS may be a multi-symbol signal that may be aggregated to accumulate power. It is e.g., a low-latency, low interference signal which may be emitted from multiple base stations.

SRS is a signal in UL which covers the full bandwidth and is spread across all subcarriers and utilizes multiple base stations at the same time. UEs may be multiplexed over the same transmitting symbol by assigning different comb patterns. 3GPP has standardized power, angular and time support for PRS such as e.g. UL-TDOA, UL-TDOA, AOD, and AOA.

When data collection is triggered for the first and second radio measurements, all first and second UEs 121, 122 or a subset of UEs will collect different measurements such as e.g. RSRP, TA, TOA, doppler shift, DL-PRS, UL-SRS, as well as sidelink info and will send them back to the network node 130, e.g. to its LMF, where a centralized algorithm may be deployed to estimate the position Y of the first antenna 111.

The text below relates to an embodiment described in Action 505 above.

By using the first radio measurements between second UEs 122 and the serving second antennas 112, the positions of the second UEs 122 connected to the second antennas 112 with known locations can be estimated. The first radio measurements may be collected in the UEs 121 or 122, and may e.g., relate to RSRP(Q), RSRI, TOA, RTT, TA, AOA, or doppler shift. The positions of the second UEs 122 may be estimated by using programmatic or AI based approaches. Depending on the type of measurements, the requirement to the number of antennas 112 at known locations are different for different position estimates.
For RSRP or TOA only, at least three second antennas 112 at known locations are required for 3D positioning, at least two second antennas 112 for 2D positioning.
For AOA only, at least three second antennas 112 at known locations are required for 3D positioning, at least two second antennas 112 are required for 2D positioning.
For AOA and TOA (plus RSRP), at least one second antenna 122 at known locations is required for 2D positioning, and at least two second antennas 112 are required for 3D positioning.

If there are second UEs 122 with known locations (e.g., via GPS), this step for those second UEs 122 are ignored, and the process goes to next step.

When the second UEs 122 positions are estimated using the measurements between the second antenna 112 locations and the second measurements between the second UEs 122 and the second antenna 112, an ensemble of estimators may be used. For example, if there are more than Nest second antennas 112 with known location connected to the second UEs 122, different sample subsets may be selected from these known antennas, e.g. by using bagging, and produce different estimations of the second UEs 122. Then some anomalous estimations may be removed if it has large variance from the average estimation. Then a mean of estimations may be calculated to give a more accurate value.

Similar technique may be used in the case of estimating the first UE 121 and the first antenna 111 sequentially.

This step basically includes collecting sidelink measurements such as second radio measurements, as well as the first radio measurements from neighbor second antenna 112 connected to a first UE 121, if any. For this part, the following measurements may be collected.
RSRP(Q), RSSI and/or RTT between first and second UEs 121, 122 in sidelink, in the second radio measurements.
RSRP(Q), RSSI from the first UEs 121 to a neighbor antenna such as the second antennas 112.

The location of all the second antennas 112 and/or second UEs 122 connected to the first UE 121 are assumed to be known or have already been estimated as described above.

From earlier steps, the network node 130 that executed the method steps and actions above, has the estimated locations of the first UEs 121 connected to the first antenna 111. In this step, the network node 130 estimates the location of the target antenna position Y from the locations of the first UEs 121. This may be done by at least two embodiments.

In some of these embodiments a method according to prior art is used to estimate the locations of the first UEs 121 but in a reverse direction, i.e., an unknown antenna position Y of the first antenna 111 is estimated from known first UEs 112 positions, instead of estimating an unknown UE position from a known antenna position.

Various techniques may be used to estimate the position of a UE in 5G, see e.g. M. R. Gholami, Wireless sensor network positioning techniques, Gothenburg: Chalmers, 2013. Concrete examples of such techniques are Downlink Angle of Departure (DL-AoD), Uplink Angle of Arrival (UL-AoA), DL Position Reference Signal (DL-PRS), UL Position Reference Signal (UL-PRS).

In some other of theses embodiments, a trained Machine learning (ML) model may be used for estimating the first antenna 111 position Y from the first UEs 121 positions.

For each first UE 121, the network node 130 extracts the first radio measurements between the first UE 121 and the first antenna 111. The first radio measurements include but are not limited to RSRP, TA, Precoder matrix, DL-PRS, UL-PRS, . . . , etc.

The network node 130 may use a trained ML model for estimating the first antenna 111 position Y from the first UEs 121 positions. An example of such a model is described below. The ML model takes as input first radio measurements between each first UE 121 and the first antenna 111 and provides the distance and direction from each first UE 121 to the first antenna 111 as output. From the distance and direction, a programmatic approach may be used to estimate the position of antenna 111. This approach may be implemented in two steps. It is also possible to use a ML model to directly estimate the position of antenna 111 from the first UEs location and the first measurements.
3. The network node 130 may aggregate inference results from all first UEs 121 to obtain an estimate of the position Y for the first antenna 111.

An ML model or model-based approach, may e.g., comprise trilateration, triangulation, or hybrid, to estimate the first antenna 111 position Y from the first UE 121 position. The method may comprise the following steps:
1) Performing first radio measurements between the first UE 121 and the first antenna 111. E.g. comprising any one or more out of: RSRP(Q), RSSI, TOA, RTT, TA, Precoder matrix, DL-PRS, UL-PRS
2) Using a Trained ML model for estimating the first antenna 111 position Y from a the first UE 121 position.
3) Using a model-based approach to solve a positioning optimization problem to estimate the first antenna position Y.

The text below relates to the determining of whether a reliability of the estimated position Y of the first antenna 111 fulfils a criterion and is described in Action 506 above.

As mentioned above, the network node 130 performs several estimates based on first radio measurements between 1.) second UEs 122 and second antennas with known locations, 2.) second radio measurements between second UEs 122 and first UEs 121 over sidelinks, and 3.) in some embodiments, further first radio measurements between first UEs 121 and the first antenna 111. All estimates are used to arrive at the final estimate of the first antenna 111 location Y. The network node 130, may then in some embodiments, determine, also referred to as estimate, the reliability of the estimated first antenna 111 location Y in terms of some metrics. Since the real location of the first antenna 111, is not available in beforehand, the accuracy evaluation may be challenging.

Such reliability estimation may be performed by the network node 130 in the following, according to an embodiment. This embodiment uses quantify variation of the first and second radio measurements based on standard variation and variances of reconstructed error, more detail in the sequel. Please assume the following definition, in which definition a network entity may be any of the UEs 121, 122, or any of the second antennas 112.

M=a set of radio measurements, such as e.g., the first and second radio measurements between first and second UEs 121, 122 over side links and between second UEs 122 and/or first UEs 121 antennas, e.g., RSRP, TA, . . . , etc. These measurements are collected from the radio links and are used to estimate the location of the antenna.

Mc=a set of reconstructed measurements from the location estimates. That is, once the estimate is available, such measurements are built up by using some measurement models, e.g. via some mathematic formulas. For example, if the distance measurements from TA and/or RTT are used to estimate the location of an antenna, then the Euclidean distance, which is I₂ norm, may be used to recalculate the distance between the first antenna 111 and the first UE 121, or the first UE 121 and the second UE 122, or the second UE 122 and the second antenna 112.
dif(mᵢ, mcᵢ)=mᵢ−mcᵢ, the difference between the measurement mᵢ from the measurement set M and the constructed measurement mcᵢ from Mc.
var(z)=variance of a random variable z.

The network node 130 quantifies reliability of the measurements between second UEs 122 and known second antenna's 112 location, the corresponding measurement set is denoted by second measurement set

$$R 1 = {\sum }_{i}^{i in second measurerents set} var ( diff ( {m}_{i} , {mc}_{i} )$$

The network node 130 quantifies reliability of the measurements between second UEs 122 and the first UEs 121 over side link, the corresponding measurement set is denoted by sidelink measurement set:

$$R 2 = {\sum }_{i}^{i in sideline measurement set} ( var ( diff ( {m}_{i} , {mc}_{i} ) )$$

The network node 130 quantifies reliability of measurements between the first UEs 121 and the first antenna 111 location, the corresponding measurement set is denoted by first measurement set:

$$R 3 = {\sum }_{i}^{i in first measurement set} var ( diff ( {m}_{i} , {mc}_{i} )$$

After all reliability of measurements above have been estimated, an Aggregated Reliability (AR) may be estimated by the network node 130, by an aggregation function, e.g., average or media of all the reliability measurements R1, R2, and R3.

Then, to decide whether the estimated of the target antenna location is reliable enough network node 130 sets a criterion, also referred to as a threshold, on the aggregated reliability AR. The threshold may be defined by telecom operators. This approach for some measurements, e.g., TA and/or TOA and/or RTT, will evaluate the accuracy of the in the context of geometry of the network.

Another approach is to calculate a confidence interval (CI), e.g., 95%, and then the maximum position error as a measure of accuracy to be the criterion, i.e., the smaller CI the more accurate position estimate.

When the network node 110 is quite certain that the estimated location of a target antenna is trustworthy. The network node 130 then updates the antenna location in the database.

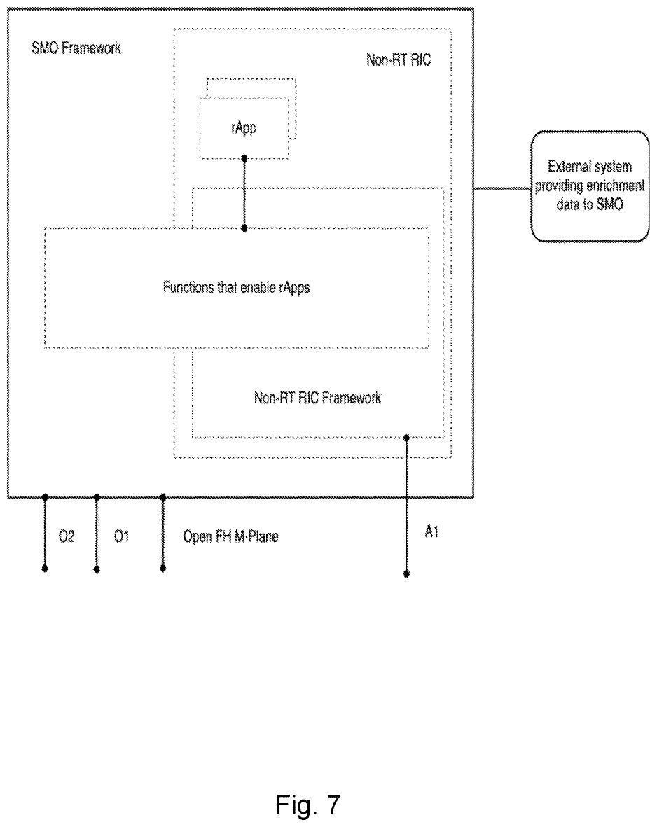

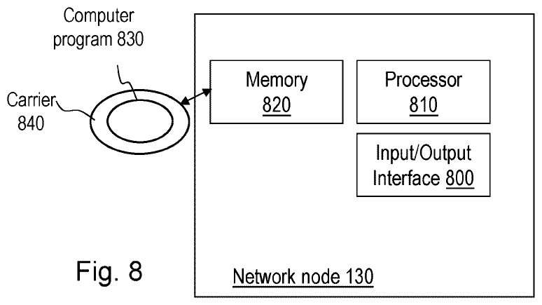

FIG. 7 high-level system view of a of Service Management and Orchestration (SMO), non-RealTime RAN Intelligent Controller (non-RT RIC) and RAN automation applications, (rAPP) from Open RAN (O-RAN) architecture. FIG. 8 illustrates a high-level system view of Service Management and Orchestration (SMO), non-RT RIC, rAPP, where the embodiments herein may be implemented.

It can be seen from the figure that different interfaces provide various sources of information. From O1, the cell trace measurements may be captured. O2 is the interface to the open cloud. A1 will provide the connection between non-real-time RAN Intelligent Controller (RIC) and near-real-time RIC. Since the positioning applications for many use cases require slow loop feedback, it can be implemented as rAPP interface automation tool in non-real-time RIC, which is part of SMO.

To perform the method actions above, the network node 130 is configured to estimate a position Y of the first antenna 111 in the wireless communications network 100.

The network node 130 may comprise an arrangement depicted in FIG. 8 network node 130 may comprise an input and output interface 800 configured to communicate in the wireless communications network 100, e.g., with the first second and third antennas and the first, second and third UEs 121, 122, 123. The input and output interface 900 may comprise a wireless receiver not shown, and a wireless transmitter not shown.

The network node 130 is further configured to identify the set of first UE 121 with a respective unknown position, that the first antenna 111 serves.

The network node 130 is further configured to obtain a known position of each respective second antenna 112 in a set of second antennas. Each second antenna 112 in the set of second antennas is adapted to serve at least one second UE 122 with an unknown position.

The network node 130 is further configured to obtain first radio measurements between:
i each second antenna 112 in the set of second antennas and its respective at least one served second UE 122, and between
ii the first antenna 111 and its respective at least one served first UE 121.

The network node 130 is further configured to obtain second radio measurements over sidelinks. The sidelinks are between each first UE 121 of the set of first UE and the respective at least one second UE 122 served by each respective second antenna 112 in the set of second antennas.

The network node 130 is further configured to estimate the position Y of the first antenna 111 based on:
the known position of each second antenna 112 in the set of second antennas,
the first radio measurements, and
the second radio measurements.

The first radio measurements, and the known position of the of each second antenna 112 in the set of second antennas, may be adapted to be comprised in cell trace measurements.

The first radio measurements may further be adapted to comprise radio measurements between:
iii each second antenna 112 in the set of second antennas and the first UE 121.

The network node 130 may further be configured to estimate the position Y of the first antenna 111 according to the following example:

The network node 130 may estimate the position of each at least one second UE 122 served by each respective second antenna 112 in the set of second antennas, based on:
the first radio measurements i between each second antenna 112 in the set of second antennas and it's respective at least one served second UE 122,
the known position of each respective second antenna 112 in the set of second antennas.

The network node 130 may further estimate the position of each of the respective first UEs 121 of the set of first UE based on:
the estimated position of each at least one second UE 122 served by each respective second antenna 112 in the set of second antennas, and
the second radio measurements.

The network node 130 may then estimate the position Y of the first antenna 111 based on the position of each of the respective first UEs 121 of the set of first UE, and the first radio measurements between ii the first antenna 111 and it's respective at least one served first UE 121.

The network node 130 may further be configured according to the following example:

The network node 130 may be configured to determine whether a reliability of the estimated position Y of the first antenna 111 fulfils a criterion.

The network node 130 may be configured to, when the criterion is not fulfilled, obtain a respective known position of third antennas 113 in a set of third antennas. Each third antenna 113 in the set of third antennas, is adapted to serve at least one third UE 123 with an unknown position.

The network node 130 may further be configured to obtain third radio measurements between:
iii each third antenna 113 in the set of third antennas and it's respective at least one served third UE 123, and between
iv the first antenna 111 and it's respective at least one served first UE 121.

The network node 130 may be configured to obtain fourth radio measurements over a respective sidelink between respective first UE 121 of the set of first UE and the respective at least one third UE 123 served by each respective third antenna 113 in the set of third antennas.

The network node 130 may be configured to reestimate the position Y of the first antenna 111 based on:
the known position of each third antenna 113 in the set of third antennas,
the third radio measurements, and
the fourth radio measurements.

The embodiments herein may be implemented through a respective processor or one or more processors, such as the processor 810 of a processing circuitry in the network node 130 depicted in FIG. 9 together with respective computer program code for performing the functions and actions of the embodiments herein. The program code mentioned above may also be provided as a computer program product, for instance in the form of a data carrier carrying computer program code for performing the embodiments herein when being loaded into the network node 130. One such carrier may be in the form of a CD ROM disc. It is however feasible with other data carriers such as a memory stick. The computer program code may furthermore be provided as pure program code on a server and downloaded to the network node 130.

The network node 130 further comprises a memory 820 comprising one or more memory units. The respective memory 820 and memory 920 comprises instructions executable by the processor in the respective first network node 111 and second network node 112. The respective memory 820 and memory 920 are arranged to be used to store e.g., radio measurements, positions, information, indications, data, configurations, communication data, and applications to perform the methods herein when being executed in the respective first network node 111 and second network node 112.

In some embodiments, a computer program 830 comprises instructions, which when executed by the processor 910, cause the at least one processor of the network node 130 to perform the actions above.

In some embodiments, a carrier 840 comprises the computer program 930, wherein the carrier 940 is one of an electronic signal, an optical signal, an electromagnetic signal, a magnetic signal, an electric signal, a radio signal, a microwave signal, or a computer-readable storage medium.

Those skilled in the art will appreciate that units in the network node 130 described above may refer to a combination of analog and digital circuits, and/or one or more processors configured with software and/or firmware, e.g. stored in the network node 130, that when executed by the respective one or more processors such as the processors described above. One or more of these processors, as well as the other digital hardware, may be included in a single Application-Specific Integrated Circuitry ASIC, or several processors and various digital hardware may be distributed among several separate components, whether individually packaged or assembled into a System-on-a-Chip (SoC).

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

### Abbreviations

Explain all abbreviations and acronyms used in the document.

| Abbreviation | Explanation |
|---|---|
| MS-RBS | Multi-standard radio base station |
| RAN | Radio access network |
| CM | Configuration management |
| e2e | End-to-end |
| UE | User equipment |
| DU | Distributed unit |
| QoS | Quality of service |
| AOA | Angle of arrival |
| RTT | Round trip time |
| RSRP | Reference signal receive power |
| RDM | Radio Domain Manager |
| SMO | Service Management and Orchestration |
| EIAP | Ericsson Intelligent Automation Platform |
| NBI | North Bound Interface |
| UL-TDOA | Uplink Time Difference of Arrival |
| OTDOA | Observed Time Difference of Arrival |

1. A method performed by a network node for estimating a position (Y) of a first antenna in a wireless communications network, the method comprising:
identifying a set of first User Equipment, UE, with a respective unknown position, that the first antenna serves,
obtaining a known position of each respective second antenna in a set of second antennas, wherein each second antenna in the set of second antennas, is serving at least one second UE with an unknown position,
obtaining first radio measurements between:
(i) each second antenna in the set of second antennas and it's respective of the at least one served second UE, and
(ii) the first antenna and it's respective of the at least one served first UE,
obtaining second radio measurements over sidelinks between each first UE of the set of first UE and the respective of the at least one second UE served by each respective second antenna in the set of second antennas, and
estimating the position (Y) of the first antenna based on:
the known position of each second antenna in the set of second antennas,
the first radio measurements, and
the second radio measurements.

2. The method according to claim 1, wherein the first radio measurements, and the known position of each second antenna in the set of second antennas, are comprised in cell trace measurements.

3. The method according to claim 1, wherein the first radio measurements, further comprises radio measurements between:
(iii) each second antenna in the set of second antennas and the first UE.

4. The method according to claim 1, wherein the estimating of the position (Y) of the first antenna is performed by:
estimating the position of each of the at least one second UE served by each respective second antenna in the set of second antennas, based on
the first radio measurements (i) between each second antenna in the set of second antennas and it's respective of the at least one served second UE, and
the known position of each respective second antenna in the set of second antennas,
estimating the position of each of the respective first UEs of the set of first UE based on:
the estimated position of each of the at least one second UE served by each respective second antenna in the set of second antennas, and
the second radio measurements, and
estimating the position (Y) of the first antenna based on the position of each of the respective first UEs of the set of first UE, and the first radio measurements between (ii) the first antenna and it's respective of the at least one served first UE.

5. The method according to claim 1, further comprising:
determining whether a reliability of the estimated position (Y) of the first antenna fulfils a criterion,
when the criterion is not fulfilled,
obtaining a respective known position of third antennas in a set of third antennas,
where each third antenna in the set of third antennas, is serving at least one third UE with an unknown position,
obtaining third radio measurements between:
(iii) each third antenna in the set of third antennas and it's respective of the at least one served third UE, and
(iv) the first antenna and it's respective of the at least one served first UE,
obtaining fourth radio measurements over a respective sidelink between a respective first UE of the set of first UE and the respective of the at least one third UE served by each respective third antenna in the set of third antennas, and
reestimating the position (Y) of the first antenna based on:
the known position of each third antenna in the set of third antennas,
the third radio measurements, and
the fourth radio measurements.

6. A computer program comprising instructions, which when executed by a processor, causes the processor to perform actions according to claim 1.

7. (canceled)

8. A network node configured to estimate a position (Y) of a first antenna in a wireless communications network, the network node further being configured to:
identify a set of first User Equipment, UE, with a respective unknown position, that the first antenna serves,
obtain a known position of each respective second antenna in a set of second antennas, wherein each second antenna in the set of second antennas, is adapted to serve at least one second UE with an unknown position, and
obtain first radio measurements between:
(i) each second antenna in the set of second antennas and it's respective of the at least one served second UE, and
(ii) the first antenna and it's respective of the at least one served first UE,
obtain second radio measurements over sidelinks between each first UE of the set of first UE and the respective of the at least one second UE served by each respective second antenna in the set of second antennas, and
estimate the position (Y) of the first antenna based on:
the known position of each second antenna in the set of second antennas,
the first radio measurements, and
the second radio measurements.

9. The network node according to claim 8, wherein the first radio measurements, and the known position of each second antenna in the set of second antennas, are adapted to be comprised in cell trace measurements.

10. The network node according to claim 8, wherein the first radio measurements further are adapted to comprise radio measurements between:
(iii) each second antenna in the set of second antennas and the first UE.

11. The network node according to claim 8, wherein the network node further is configured to estimate the position (Y) of the first antenna by:
estimating the position of each of the at least one second UE served by each respective second antenna in the set of second antennas, based on
the first radio measurements (i) between each second antenna in the set of second antennas and it's respective of the at least one served second UE, and
the known position of each respective second antenna in the set of second antennas,
estimating the position of each of the respective first UEs of the set of first UE based on:
the estimated position of each of the at least one second UE served by each respective second antenna in the set of second antennas, and
the second radio measurements, and
estimating the position (Y) of the first antenna based on the position of each of the respective first UEs of the set of first UE, and the first radio measurements between (ii) the first antenna and it's respective of the at least one served first UE.

12. The network node according to claim 8, further being configured to:
determine whether a reliability of the estimated position (Y) of the first antenna fulfils a criterion,
when the criterion is not fulfilled,
obtain a respective known position of third antennas in a set of third antennas,
where each third antenna in the set of third antennas, is adapted to serve at least one third UE with an unknown position,
obtain third radio measurements between:
(iii) each third antenna in the set of third antennas and it's respective at least one served third UE, and
(iv) the first antenna and it's respective of the at least one served first UE,
obtain fourth radio measurements over a respective sidelink between respective first UE of the set of first UE and the respective of the at least one third UE served by each respective third antenna in the set of third antennas, and
reestimate the position (Y) of the first antenna based on:
the known position of each third antenna in the set of third antennas,
the third radio measurements, and
the fourth radio measurements.
